(19) United States
(12) Patent Application Publication
(10) Pub. No.: US 2015/0014457 A1
(43) Pub. Date: Jan. 15, 2015

(54) Feeder Mixer with Magnet for Extracting Metals from the Feed

(71) Applicant: Hi-Tec Industries Inc., Portage la Prairie (CA)

(72) Inventor: John Close, Portage la Prairie (CA)

(21) Appl. No.: 14/258,433

(22) Filed: Apr. 22, 2014

Related U.S. Application Data
(60) Provisional application No. 61/843,186, filed on Jul. 5, 2013.

(51) Int. Cl. B03C 1/14; B26D 3/00; B03C 1/30

(52) U.S. Cl. CPC B03C 1/145; B03C 1/30; B26D 3/00
USPC 241/98; 209/225

(57) ABSTRACT

Apparatus for mixing feed materials for animals includes a tub carried on a trailer with at least one mixing auger mounted in the tub standing upwardly from the base with a peripheral flight for rotating about an upstanding axis and carrying a plurality of cutting members extending outwardly. A pair of adjustable restricting plates is carried in respective slots on the peripheral wall at diametrically opposite positions at a height on the peripheral wall aligned with said at least one mixing auger and movable inwardly and outwardly of the wall. Each of the plates carries an elongate magnet along its innermost edge so as to be spaced from and separate from the wall of the tub for attracting and collecting metallic materials in the feed.

This application claims the benefit under 35 USC 119 (e) of Provisional Application 61/843186 filed Jul. 5, 2013.

This invention relates to a vertical feeder mixer for shredding and mixing feed materials for supply to animals and particularly to an arrangement of this type which includes a magnet for extracting metals from the feed.

### BACKGROUND OF THE INVENTION

It is known to prepare fodder, particularly for cattle, by using shredding and mixing trucks provided with a vertical screw feeder contained within a tub shaped as an inverted frustum-shaped container typically arranged on a wheeled chassis. Inside the tub is provided a rotating helical screw feeder which is arranged vertically with the outer profile lying on a substantially conical surface.

Cutters are fixed around the periphery of the screw feeder and are suitable to shred the product being mixed, which is appropriately loaded from above and is constituted largely by fibrous material such as hay and straw with the optional addition of protein supplements, ensilaged products, flours, et cetera.

To control the rate of the rotary motion of the product being processed entrained by the rotating screw feeder, in the lower part of the tub there are restrictors, which are arranged vertically in substantially radial positions which can be inserted and removed through slots provided in the wall of the tub.

An arrangement of this type is shown for example in WO 03/030632 of Faccia published Apr. 17, 2003, the disclosure of which is incorporated herein by reference or to which reference may be made for further details of mixers of this type.

### SUMMARY OF THE INVENTION

It is one object of the invention to provide an arrangement of this type which includes a magnet for extracting metals from the feed.

According to one aspect of the invention there is provided an apparatus Apparatus for mixing and supplying feed materials for animals comprising:
a tub having a peripheral wail defining an open top into which the feed materials can be supplied for mixing and a base;
at least one mixing auger mounted in the tub so as to stand upwardly from the base;
said at least one mixing auger having a rotatable upstanding cylinder carrying a peripheral flight for rotation about an upstanding axis of the cylinder;
at least one adjustable restricting element on the peripheral wall;
said at least one restricting element being positioned at a height on the peripheral wall aligned with said at least one mixing auger;
said at least one restricting element extending inwardly from the peripheral wall so as to engage and restrict movement of said feed material as the feed materials are carried around the peripheral wall of the tub by said at least one mixing auger;
said at least one restricting element having mounted thereon a magnet for attracting and collecting metallic materials in the feed materials.

Preferably the magnet is mounted on an edge of the restricting element located furthest into the tub and comprises an elongate element or bar mounted along the restricting element at or adjacent the edge where the elongate element extends upwardly within the tub, that is longitudinally of the auger so as to engage the feed material over an extended part of the height of the auger.

Preferably the magnet comprises a tube such as stainless steel encasing a plurality of rare earth magnets. However other types of magnet can be used.

Preferably the mixing auger includes a plurality of cutting members extending outwardly from the periphery of the flight.

The above arrangement has the major advantage that it can locate the magnet at a position on the restrictor spaced inwardly of an inside surface of the tub so as to be separate from and spaced from the tub. This places the magnet further into the material and avoids the effects of the wall of the tub on the magnet or the material collecting on the magnet.

Preferably the restrictor comprises a planar plate member which is mounted within slot in a wall of the tub generally at right angles to the wall for adjustment movement through the slot inwardly and outwardly of the wall of the tub.

Preferably the magnet is mounted on an inside edge of the plate member so s to be spaced as far as possible into the material and away from the wall. However the magnet can be located on one side face of the plate, such as the downstream side of the plate, but preferably adjacent the edge of the plate.

Preferably the plate member is pivotal about an axis at one end of the slot so as to adjust the inner edge of the late inwardly and outwardly of the side wall of the tub.

Preferably the plate member has a handle on an outer side of the wall of the tub for manual adjustment for example using a plurality of adjustment holes allowing a selection of a distance of penetration of the plate member into the tub.

Preferably there are at least two restrictors at diagonally opposite positions on the tub wall and each carries a magnet. There can be additional restrictors for increased effect but typically two such restrictors at the diagonally opposed positions in suitable

The tub can include a single mixing auger within the tub or there can be a plurality of horizontally spaced mixing augers side by side within the tub.

### BRIEF DESCRIPTION OF THE DRAWINGS

One embodiment of the invention will now be described in conjunction with the accompanying drawings in which:

FIG. 1 is a top plan view of a feeder mixer according to the present invention.

FIG. 2 is a cross-sectional view along the lines 2-2 of the feeder mixer of FIG. 1.

FIG. 3 is an isometric view of one restricting element of the feeder mixer of FIG. 1.

FIG. 4 is a cross-sectional view along the lines 4-4 of FIG. 3 of the feeder mixer of FIG. 1.

FIG. 5 is a cross-sectional view along the lines 5-5 of FIG. 4 of the feeder mixer of FIG. 1.

In the drawings like characters of reference indicate corresponding parts in the different figures.

### DETAILED DESCRIPTION

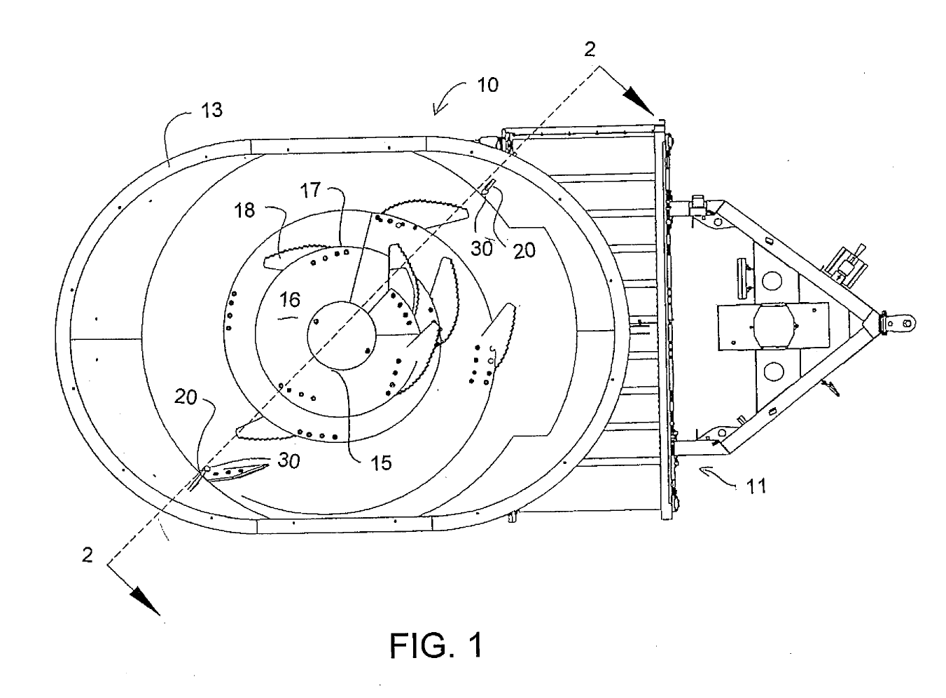

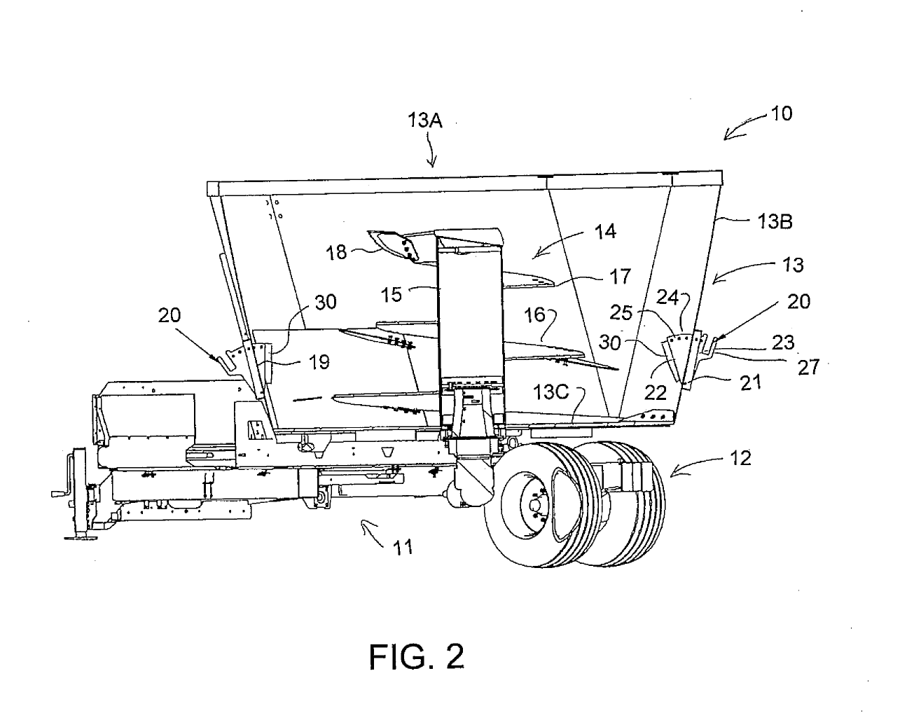

With reference to FIGS. 1 and 2, an apparatus for shredding and mixing feed material for animals is generally designated by the reference numeral 10. The apparatus 10 comprises, on a chassis 11 with wheels 12, which in this case is towed, a container or tub 13 that is shaped approximately like an inverted frustum, is open at an upper region at an open top 13A, and contains shredding and mixing auger 14.

The shredding and mixing auger 14 comprise one or more rotating screw feeders, which have vertical axes of core cylinder 15; where each screw feeder has an external profile 17 of a flight 16 that lies on an imaginary substantially conical surface at which shredding cutters 18 are fitted.

A pair of restrictors 20 are provided each at a respective slot in the wall and arranged at diametrically opposed positions. Each is a flat plate shaped substantially like a circular sector with two side edges 22 and 23 and an arcuate upper edge 24. Each is hinged at a bottom pin 21 in a hole 21A to the wall of the container 13. The restrictors 20 are mounted at their respective vertices 21B so that the flat plate forming the restrictor stands substantially in a vertical arrangement on substantially diametrically opposed positions of the container 13 and can be inserted and removed through appropriately provided slots 19 in the wall of the container 13. The plate includes a series of holes 25 adjacent the arcuate upper edge 24 to cooperate with a pin at the wall of the tub to adjust the angle of the edge 22 to the wall around the pin 21. Manual adjustment is carried out by a handle 27 located on the outer edge 23 so as to project outside of the tub 13 beyond the end of the slot 19 so that the handle remains outside the tub as the edge 22 of the plate is moved inwardly of and outwardly of the wall of the tub 13.

The tub 13 thus has a base 13C and a peripheral wall 13B defining an open top 13A into which the feed materials can be supplied for mixing. The feeder auger 14 forms a mixing auger mounted in the tub so as to stand upwardly from the base with the plurality of cutting members 18 extending outwardly from the periphery 17 of the flight 16. The adjustable restricting elements 20 on the peripheral wall are positioned at a height on the peripheral wall aligned with the mixing auger 14 to restrict the rotation of the material as it is driven around the tub with the auger.

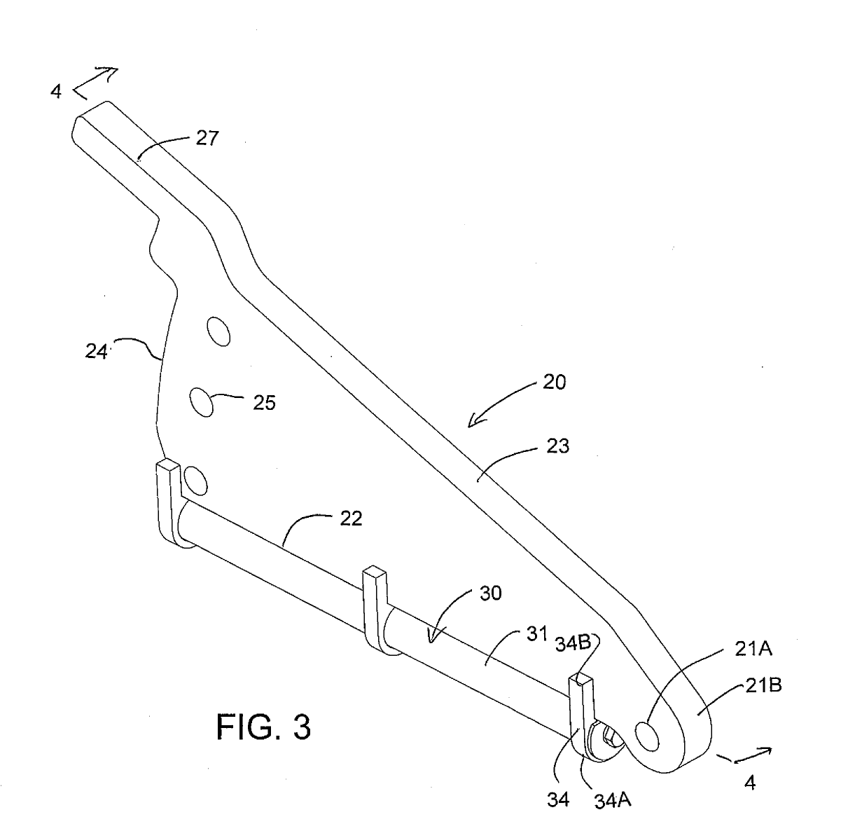

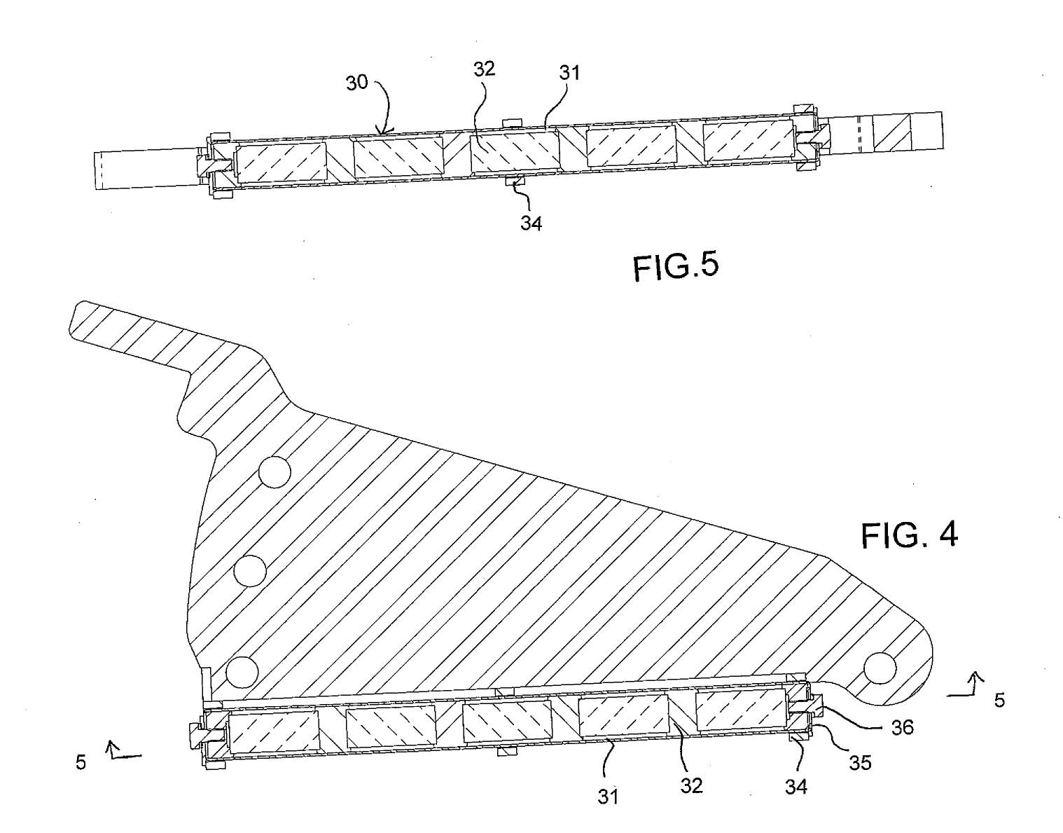

As best shown in FIG. 3, each restricting element has mounted thereon a magnet 30 mounted on the edge 22 of the restrictor 20 located furthest into the tub for attracting and collecting metallic materials in the feed.

The magnet is an elongate stainless steel tube or sleeve 31 containing a row of rare earth magnets with the sleeve mounted by straps 34 along the restrictor. The sleeve 31 is mounted at a position on the edge 22 of the restrictor spaced inwardly of an inside surface of the tub so that the sleeve 31 extends upwardly within the tub. Thus the magnet is mounted on the restrictor 20 so as to be separate from and spaced from the wall 13B of the tub 13. The sleeve 31 has a diameter approximately equal to the width of the plate forming the restrictor so that the sleeve extends to the sides of the plate only to a small extent. The length of the sleeve is approximately equal to the length of the edge 22. The straps 34 include a part cylindrical base portion 34A which surrounds the sleeve 31 and a pair of legs which extend along the front and rear faces of the plate and are attached thereto. Each end of the sleeve 31 is closed by a cap 35 which is held in place by a screw 36.

Since various modifications can be made in my invention as herein above described, and many apparently widely different embodiments of same made within the spirit and scope of the claims without department from such spirit and scope, it is intended that all matter contained in the accompanying specification shall be interpreted as illustrative only and not in a limiting sense.

1. Apparatus for mixing and supplying feed materials for animals comprising:
a tub having a peripheral wall defining an open top into which the feed materials can be supplied for mixing and a base;
at least one mixing auger mounted in the tub so as to stand upwardly from the base;
said at least one mixing auger having a rotatable upstanding core member carrying a peripheral flight for rotation about an upstanding axis of the core member;
at least one adjustable restricting element on the peripheral wall;
said at least one restricting element being positioned at a height on the peripheral wall aligned with said at least one mixing auger;
said at least one restricting element extending inwardly from the peripheral wall so as to engage and restrict movement of said feed material as the feed material is carried around the peripheral wall of the tub by said at least one mixing auger;
said at least one restricting element having mounted thereon a magnet for attracting and collecting metallic materials in the feed materials.

2. The apparatus according to claim 1 wherein said at least one mixing auger includes a plurality of cutting members extending outwardly from the periphery of the flight.

3. The apparatus according to claim 1 wherein the magnet is mounted on an edge of the restricting element located furthest into the tub.

4. The apparatus according to claim 1 wherein the magnet is an elongate element mounted along the restricting element.

5. The apparatus according to claim 4 wherein the elongate element extends upwardly within the tub.

6. The apparatus according to claim 1 wherein the magnet comprises a tube encasing a plurality of rare earth magnets.

7. The apparatus according to claim 6 wherein the tube is stainless steel.

8. The apparatus according to claim 1 wherein the magnet is located at a position on the restricting element spaced inwardly of an inside surface of the tub.

9. The apparatus according to claim 1 wherein the magnet is mounted on the restricting element so as to be separate from and spaced from the tub.

10. The apparatus according to claim 1 wherein the restricting element comprises a plate member which is mounted within slot in a wall of the tub for adjustment movement through the slot inwardly and outwardly of the wall of the tub.

11. The apparatus according to claim 10 wherein the magnet is mounted on an inside edge of the plate member.

12. The apparatus according to claim 10 wherein the plate member is pivotal about an axis at one end of the slot.

13. The apparatus according to claim 10 wherein the plate member has a handle on an outer side of the wall of the tub.

14. The apparatus according to claim 10 wherein the plate member has a plurality of adjustment holes allowing a selection of a distance of penetration of the plate member into the tub.

15. The apparatus according to claim 1 wherein there are at least two restricting elements at opposite positions on the tub wall and each carries a magnet.

16. The apparatus according to claim 1 wherein there is a single mixing auger within the tub.

17. The apparatus according to claim 1 wherein there is a plurality of horizontally spaced mixing augers within the tub.
